(19) United States
(12) Patent Application Publication
(10) Pub. No.: US 2012/0143937 A1
(43) Pub. Date: Jun. 7, 2012

(54) Method of Communication Between an Embedded Server and a Remote Server

(75) Inventors: Matthieu BOISDE, Gradignan (FR); Florent Oulieres, Merignac (FR)

(73) Assignee: OBERTHUR TECHNOLOGIES, Levallois-Perret (FR)

(21) Appl. No.: 13/157,117

(22) Filed: Jun. 9, 2011

(30) Foreign Application Priority Data
Dec. 3, 2010 (FR) 10/60058

(51) Int. Cl. G06F 15/16

(52) U.S. Cl. 709/201

(57) ABSTRACT

A communications method implemented by a programmable appliance for exchanging data between a first server hosted in an electronic entity connected to said programmable appliance and a remote second server, via a browser executed by said programmable appliance, the communications method comprising:
a step of obtaining from the first server a file including instructions that are interpretable by said browser; and
a step of the browser interpreting the instructions of said file;
wherein the step of interpreting the instructions comprises:
   a step of sending a first message to the second server;
   a step of receiving a second message from the second server in response to sending the first message, the second message including data; and
   a step of sending a third message to the first server, the third message including said data.

### BACKGROUND OF THE INVENTION

The invention relates to the field of computing. The present invention relates more particularly to exchanging data between a first server housed in an electronic entity connected to a programmable appliance and a remote second server via a browser executed by the programmable appliance.

Document FR 2 923 337 describes a method of exchanging data in which a server embedded in a subscriber identity module (SIM) card inserted in a mobile telephone communicates with a remote server of a bank via a browser executed by the mobile telephone.

Specifically, the browser may obtain a hypertext mark-up language (HTML) page from the embedded server, which page contains, in an HTML tag, a redirection instruction to a universal resource locator (URL) that contains the address of the remote server and data for transmitting to the remote server. Interpretation of the HTML page by the browser involves executing that redirection instruction, and thus causes an http request to be sent to the remote server, the request including data.

Conversely, the browser may obtain from the remote server an HTML page that contains, in an HTML tag, a redirection instruction to a URL, which instruction contains the address of the embedded server and data for forwarding to the embedded server. Interpreting the HTML page by the browser involves executing said redirection instruction and thus causes an http request to be sent to the embedded server, which request includes data.

Thus, the browser enables data to be exchanged between the embedded server and the remote server. Nevertheless, that data exchange method presents several drawbacks.

Since each redirection instruction is contained in a respective HTML page, each sending of data to the embedded server or to the remote server involves the browser displaying an HTML page, thereby slowing down the exchange of data. Furthermore, the data exchange may be viewed by the user of the mobile telephone.

Secondly, if one of the servers does not respond, the only escape mechanism provided is the browser displaying an error message.

Finally, a URL address presents a standardized maximum size, thereby limiting the quantity of data that can be sent.

Above-mentioned document FR 2 923 337 also mentions that a command may be included in a JavaScript script. Nevertheless, no implementation detail is described. It is understood that the command is the redirection instruction to a URL address, which instruction may be included in a JavaScript script as a variant to including the redirection instruction in an HTML tag. That implementation does not make it possible to overcome the above-mentioned drawbacks.

There therefore exists a need for a communications method enabling more effective data exchange to be achieved between two servers via a browser.

### OBJECT AND SUMMARY OF THE INVENTION

The invention provides a communications method implemented by a programmable appliance, the method being for exchanging data between a first server hosted in an electronic entity connected to said programmable appliance and a remote second server, via a host program executed by said programmable appliance, the communications method comprising:
a step of obtaining from the first server a file including instructions that are interpretable by said host program; and
a step of the host program interpreting the instructions of said file;

wherein the step of interpreting the instructions comprises:
a step of sending a first message to the second server;
a step of receiving a second message from the second server in response to sending the first message, the second message including data; and
a step of sending a third message to the first server, the third message including said data.

Correspondingly, the invention also provides an electronic entity including a memory having stored therein a file including instructions interpretable by a host program and a program for implementing a first server housed in the electronic entity, and transmission means for transmitting said file to a programmable appliance that includes a host program, wherein said file comprises:
instructions for sending a first message to a remote second server;
instructions for receiving a second message from the second server in response to sending the first message, the second message including data; and
instructions for sending a third message to the first server, the third message including said data.

In other words, in the invention, a single file contains instructions for sending a first message to the remote server, for receiving a response, and for forwarding the data contained in the response to the first server. There is no need to display various HTML pages and data exchange can therefore be faster. Furthermore, there is no need to display the received data.

The host program may include a browser and the file may include a JavaScript script that is interpretable by the browser. Under such circumstances, the JavaScript script may include instructions for sending the first message and the second message, making use of the asynchronous JavaScript and XML (AJAX) technique.

In a variant, the host program may include a module suitable for interpreting a Flash program or a Java program, the file then including a Flash program or a Java program.

The file may include instructions for sending the first message and the second message, said send instructions including GET type or POST type http request send instructions.

The use of this type of request makes it possible to send a large quantity of data.

In an implementation, the step of interpreting instructions includes a step of verifying that a response has been received to a message sent to the second server.

Under such circumstances, the step of interpreting instructions may also include, in the absence of a response being received to the first message, a step of sending the first message to a third server. In a variant, the step of interpreting instructions may include, in the absence of a response being received to the first message, a step of resending the first message to the second server.

In an implementation, said step of interpreting instructions includes a test step relating to said data.

The various characteristics mentioned above enable the host program to adapt the way in which data is exchanged to actual circumstances, e.g. in the event of it not being possible to communicate with the remote server.

In an implementation, the electronic entity is releasably connected to said programmable appliance, said step of obtaining a file and said step of interpreting instructions of the file being performed in response to detecting connection of the electronic entity to the programmable appliance.

### BRIEF DESCRIPTION OF THE DRAWINGS

Other characteristics and advantages of the present invention appear from the following description made with reference to the accompanying drawings that show an embodiment having no limiting character. In the figures:

FIG. 1 shows an electronic entity in an embodiment of the invention, in its environment;

FIG. 2 shows the main steps of a communications method in an implementation of the invention;

FIG. 3 shows a first variant of the FIG. 2 step of interpreting instructions; and

FIG. 4 shows a second variant of the FIG. 2 step of interpreting instructions.

### DETAILED DESCRIPTION OF EMBODIMENTS

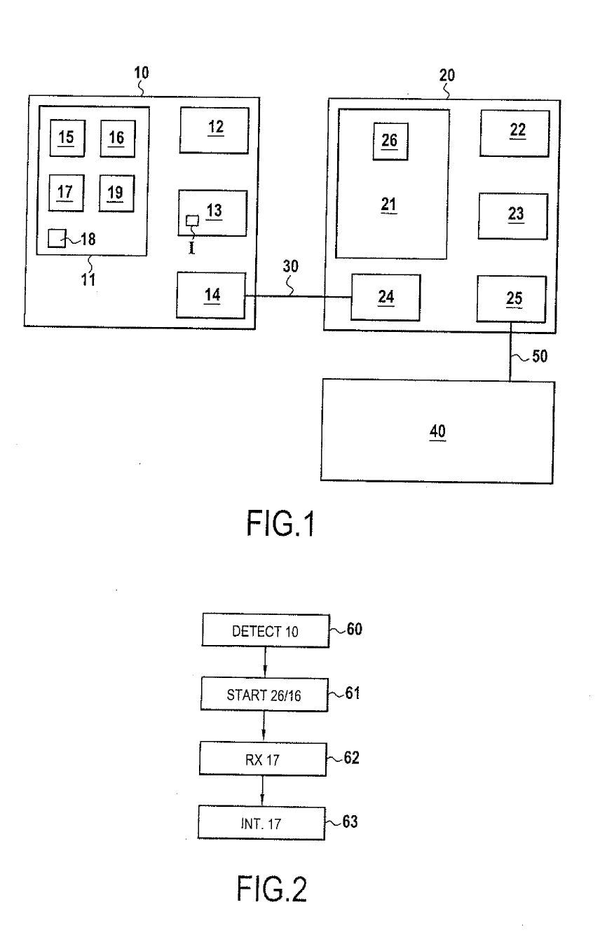

FIG. 1 shows an electronic entity 10 releasably connected to a programmable appliance 20 and a remote server 40. Below, there is a description of an exchange of data between a server hosted in the electronic entity 10 and the remote server 40, via a browser executed by the programmable appliance 20.

The electronic entity 10 is a portable electronic device that presents the hardware architecture of a computer. Thus, the electronic entity 10 has a non-volatile memory 11, a microprocessor 12, a volatile memory 13, and an interface 14. The microprocessor 12 serves to execute computer programs stored in the non-volatile memory 11, while making use of the volatile memory 13. Via a link 30, the interface 14 serves to communicate with the programmable appliance 20.

In a first variant, the electronic entity 10 is in the form of an independent portable device that may be releasably connected to the programmable appliance 20, while remaining outside the programmable appliance 20.

For example, the electronic entity 10 may be a portable multimedia reader or a storage device commonly referred to as a USB “stick” (where USB stands for universal serial bus). Under such circumstances, the non-volatile memory 11 may comprise a memory medium releasably housed in the electronic entity 10, e.g. a SIM card or a microSD card (where SD stands for secure digital). Under such circumstances, and likewise, the link 30 may include a USB connector. The link 30 may also be a wireless link, for example a short-range wireless link of the near-field communication (NFC) type or a medium-range link (range less than 100 meters (m), preferably less than 50 m, or even less than 30 m), e.g. a link complying with the Zigbee standard or the Bluetooth standard.

In another variant, the electronic entity 10 is in the form of a smart card (e.g. a SIM card) or a memory card (e.g. a microSD card) that is releasably housed in the programmable appliance 20. Under such circumstances, the link 30 may comprise a standardized connector corresponding to the format of the electronic entity 10.

In its non-volatile memory 11, the electronic entity 10 includes in particular a computer program 15 that, on being executed by the microprocessor 12, constitutes a web server hosted in the electronic entity 10. Below, reference 15 is also used to designate the server corresponding to the computer program 15.

The non-volatile memory 11 also includes a web page 16, e.g. in HTML format or in php (a scripting language), a file 17 containing interpretable instructions, a key 18, and a program 19 including, in particular, an authentication function. By way of example the file 17 is a JavaScript script or a Java or Flash program.

When executed by the microprocessor 12, the program 19 serves to authenticate the user of the electronic entity 10. For example, during authentication, the user is invited to input a code by using a man/machine interface of the electronic entity 10 or the programmable appliance 20. The program 19 then stores information in its volatile memory 13, which information I specifies that the user of the electronic entity 10 has been identified.

The programmable appliance 20 presents the hardware architecture of a computer. Thus, the programmable appliance 20 comprises a non-volatile memory 21, a microprocessor 22, a volatile memory 23, a first interface 24, and a second interface 25. The microprocessor 22 serves to execute computer programs stored in the non-volatile memory 21, while using the volatile memory 23. The interface 24 makes it possible to communicate over the link 30 with the electronic entity 10. The interface 25 makes it possible to communicate over the link 50 with the remote server 40.

The programmable appliance 20 may for example be in the form of a personal computer (PC) or a mobile telephone. By way of example, the link 50 may be a link using the Internet or a mobile telephone network.

In its non-volatile memory 21, the programmable appliance 20 includes in particular a computer program referred to as a host program 26.

In a variant, the file 17 of the electronic entity 10 comprises a JavaScript script and the host program 26 is a browser suitable for interpreting the script, for example the Internet Explorer browser or the Firefox browser. In another variant, the file 17 comprises a program, e.g. a Flash program or a Java program, and the host program 26 comprises a browser associated with an additional module suitable for interpreting the program of the file 17, e.g. a Flash plugin or a Java virtual machine.

Finally, the remote server 40 that is capable of communicating with the programmable appliance 20 over the link 50 is itself a server of a service provider. For example, the server 40 is a bank server.

With reference to FIG. 2, there follows a description of the main steps in a communications method implemented by the programmable appliance 20 to enable data to be exchanged between the server 15 and the server 40. FIG. 2 applies to the variant in which the electronic entity 10 is in the form of an independent portable device that may be releasably connected to the programmable appliance 20, while remaining situated outside the programmable appliance 20.

The programmable appliance 20 is programmed to detect the connection with the electronic entity 10 and to obtain and execute a predetermined file (e.g. an “autorun.inf” file, not shown) that is stored in the non-volatile memory 11, and to do so in response to a connection being made with the electronic entity 10.

Thus, the communications method begins with a step 60 during which the programmable appliance 20 detects that a user has connected the electronic entity 10 via the link 30, and it obtains the “autorun.inf” file from the electronic entity 10.

Thereafter, in step 61, the programmable appliance 20 executes the “autorun.inf” file. This file includes a call to the browser of the host program 26 associated with the URL address of the web page 16 as a parameter. Thus, in step 61, the browser starts and then processes the web page 16.

The web page 16 contains a command for calling the file 17. For example, when the file 17 is a JavaScript script, the web page 16 includes a command of the type:

<script src=“FileName17.js” type=“text/javascript”></script>

Thus, in step 62, the programmable appliance 20 obtains the file 17.

Thereafter, in step 63, the host program 26 interprets the instructions contained in the file 17. The instructions of the file 17 manage all of the data exchange between the server 15 and the server 40 via the host program 26. More precisely, by interpreting these instructions, the host program 26 causes requests to be sent to the servers 15 and 40 and it obtains and processes the response received.

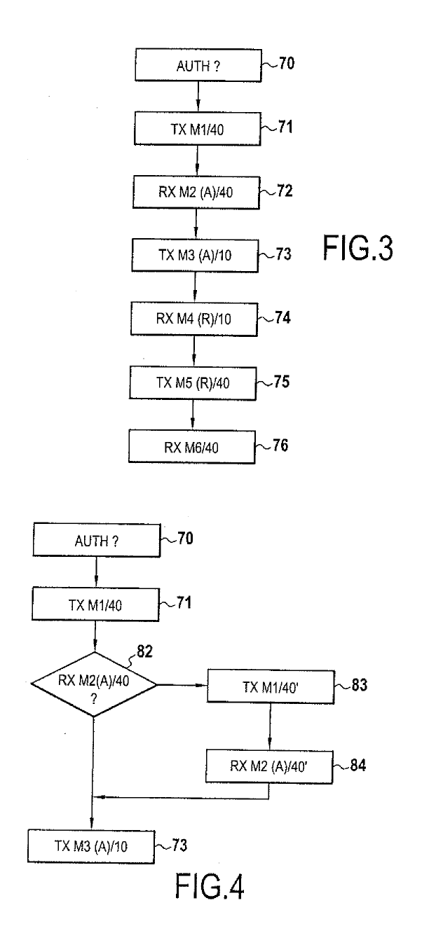

FIG. 3 shows a first example of the running of the step 63. Steps 70 to 76 of FIG. 3 are performed by the host program 26 while it interprets the instructions of the file 17. For example, when the file 17 is a JavaScript script and the host program 26 is a browser, then steps 70 to 76 correspond to respective instructions of the script to be interpreted by the browser.

In step 70, the host program 26 sends to the server 15 a request to verify the authentication of the user. The server 15 verifies that the information I is present in the volatile memory 13, and if so it gives a positive response. Thus, if the host program 26 receives a positive response from the server 15 in step 70, then it moves on to step 71.

In step 71, the host program 26 sends a message M1 to the remote server 40. The message M1 contains a request to obtain a challenge.

On receiving the message M1, the server 40 generates a random number, referred to as challenge A, and sends it to the host program 26.

Thus, in step 72, the host program 26 receives a message M2 from the server 40. The message M2 contains the challenge A as its data.

Thereafter, in step 73, the host program 26 sends a message M3 to the server 15. The message M3 contains the challenge A as its data.

In response to receiving the message M3, the server 15 calculates the response R to the challenge A by using the key 18 and a cryptographic algorithm, and it sends the response R to the host program 26.

Thus, in step 74, the host program 26 receives a message M4 from the server 15. The message M4 contains the response R as its data.

Thereafter, in step 75, the host program 26 sends a message M5 to the server 40. The message M5 contains the response R as its data.

In response to receiving the message M5, the server 40 verifies that the response R is correct. For example, the server 40 compares the response R with a response R′ that it has itself calculated as a function of the challenge A and of a key that is symmetrical to the key 18. If the response R is correct, the server 40 responds positively to the host program 26.

Thus, in step 76, the host program 26 receives a message M6 from the server 40 indicating that the electronic entity 10 has been correctly authenticated with the server 40. Under such circumstances, the host program 26 displays an authentication message over the man/machine interface of the programmable appliance 20.

There follows an example of instructions that may be contained in the file 17, applicable to a JavaScript script using the AJAX technique in the context of the JQuery application (http://www.jquery.com), and corresponding to steps 71 to 73:

/*Comments:

Send a request to remote server and obtain a challenge

in response

*/

function getChallenge( ){

jQuery.ajax({

type: ‘GET’ /*define http request of the GET type */
data Type: ‘jsonp’/* Add jsonp option on call to an

external domain */

jsonpCallback: ‘callback’ /* name of the response

function to the jsonp call */

url: ‘https://www.mybank.com/HomeBanking.cgi’ /* url

of remote server */

success: answerChallenge(response) /* process the

response in the function answerChallenge( ) */

});

}
/* Comments:

Send the challenge to the electronic entity for

authentication calculation and obtain encrypted data in
response
*/
function answerChallenge(response){

jQuery.ajax({

type: ‘POST’ /* define http request as type POST for

sending data */

data: ({A: response.challenge}) /* Add the parameter

A containing the previously-supplied challenge */

url: ‘authenticate’ /* url of the page for

calculating the cryptogram in the electronic entity */

success: responseChallenge(data) /* process the

response in the function responseChallenge( ) */

});

}

It can thus be seen that it suffices for the browser of the host program 26 to obtain and process a single web page 16 in order to enable the data A and R to be exchanged between the servers 15 and 40. The steps 70 to 76 performed while interpreting instructions of the file 17 do not require additional web pages to be displayed.

Furthermore, in the example given, the sending of the messages M1 and M3 corresponds to http requests of the GET type or of the POST type. The reception of the message M2 corresponds to an http response received in response to a request of this type. The amount of data transmitted, in particular the sizes of the challenge A and of the response R are therefore not limited by the maximum size of a URL address. For example, the amount of data transmitted may be of the order of 1 megabyte. Furthermore, with a request of the POST type, the data transmitted is not to be displayed and is therefore not visible to the user.

It is known that JavaScript imposes security restrictions that prevent reaching web domains that are external to or different from the domain from which the JavaScript file was loaded, i.e. in this example the domain to which the server 15 belongs. In this example, the messages sent to the remote server 40 therefore need to be blocked by the browser of the host program 26. In the example of instructions given above, in order to overcome this limitation, the requests are formatted using the JavaScript Object Notation with Padding (JSONP) technique.

FIG. 4 shows a second example of how the step 63 may be run.

Steps 70 and 71 are identical to those described above with reference to FIG. 3. After step 71, the host program 26 moves on to step 82 where it verifies whether a message M2 has been received from the server 40. For example, the host program 26 verifies that the message M2 has been received within a determined delay.

If the message M2 was received within the determined delay, then the host program 26 passes on to step 73 identical to that described with reference to FIG. 3, and communication continues as described above. Otherwise, if no message M2 is received within the determined delay, then the host program 26 moves on to step 83.

In step 83, the host program 26 resends the message M1, but to an alternative server referenced 40′. Then, in step 84, the host program 26 receives a message M2 from the alternative server 40′. The message M2 contains the challenge A as its data. Thereafter, the host program 26 moves on to step 73, and communication continues as described above.

In the example of FIG. 3, the instructions of the file 17 cause the host program 26 to act merely as an intermediary for sending requests and receiving responses. By way of comparison, in the example of FIG. 4, the instructions of the file 17 lead to the host program 26 taking on a higher-level role of managing the exchange of data.

More precisely, in the example of FIG. 4, the host program 26 may decide, in step 82 in which the reception of a message is verified, to contact an alternative server. In a variant that is not shown, the host program 26 resends the message M1 to the same server 40 for a new attempt. In a variant that is not shown, the host program 26 could also perform a test step on the transmitted data, e.g. relating to the challenge A and/or to the response R, and it could adapt the way the communications continues as a function of the result of this test. Thus, the instructions of the file 17, when interpreted by the host program 26, serve to adapt the way data is exchanged between the server 15 and a remote server to actual circumstances, in particular when it is impossible to reach the remote server.

The above description relates to an example in which the host program 26 obtains a web page 16 that calls a file 17 containing instructions. In a variant, the instructions corresponding to above-described step 63 are contained directly in the web page 16.

The above description relates to an example in which the host program 26 obtains the file 17 (step 62) and interprets the instructions that it contains (step 63) in response to detecting the connection of the electronic entity 10 (step 60). In a variant, in particular when the electronic entity 10 is housed in the programmable appliance 20, the steps 62 and 63 are executed in response to an instruction from the user of the programmable appliance 20, e.g. an instruction to access the web page 16.

The electronic entity 10 enables a user to transport personal data (multimedia data, documents, . . . ) and constitutes a kind of “virtual me” of the user.

What is claimed is:

1. A communications method implemented by a programmable appliance for exchanging data between a first server hosted in an electronic entity connected to said programmable appliance and a remote second server, via a browser executed by said programmable appliance, the communications method comprising:
a step of obtaining from the first server a file including instructions that are interpretable by said browser; and
a step of the browser interpreting the instructions of said file;
wherein the step of interpreting the instructions comprises:
a step of sending a first message to the second server;
a step of receiving a second message from the second server in response to sending the first message, the second message including data; and
a step of sending a third message to the first server, the third message including said data.

2. A communications method according to claim 1, wherein said file comprises a JavaScript script that is interpretable by the browser.

3. A communications method according to claim 2, wherein said JavaScript script includes instructions for sending the first message and the second message, using the AJAX technique.

4. A communications method according to claim 1, wherein said browser includes a module suitable for interpreting a Flash program or a Java program, the file including a Flash program or a Java program.

5. A communications method according to claim 1, wherein said file includes instructions for sending the first message and the second message, said send instructions including GET type or POST type http request send instructions.

6. A communications method according to claim 1, wherein said step of interpreting instructions includes a step of verifying that a response has been received to a message sent to the second server.

7. A communications method according to claim 6, wherein said step of interpreting instructions includes, in the absence of a response being received to the first message, a step of sending the first message to a third server.

8. A communications method according to claim 6, wherein said step of interpreting instructions includes, in the absence of a response being received to the first message, a step of resending the first message to the second server.

9. A communications method according to claim 1, wherein said step of interpreting instructions includes a test step relating to said data.

10. A communications method according to claim 1, wherein said electronic entity is releasably connected to said programmable appliance, said step of obtaining a file and said step of interpreting instructions of the file being performed in response to detecting connection of the electronic entity to the programmable appliance.

11. An electronic entity including a memory having stored therein a file including instructions interpretable by a browser and a program for implementing a first server housed in the electronic entity, and transmission means for transmitting said file to a programmable appliance that includes a browser, wherein said file comprises:
instructions for sending a first message to a remote second server;
instructions for receiving a second message from the second server in response to sending the first message, the second message including data; and
instructions for sending a third message to the first server, the third message including said data.
